(19) United States
(12) Patent Application Publication
(10) Pub. No.: US 2016/0332563 A1
(43) Pub. Date: Nov. 17, 2016

(54) TAIL LAMP ASSEMBLY FOR A PICKUP TRUCK

(71) Applicant: Chiung-Yu Tseng, Tainan City (TW)

(72) Inventor: Chiung-Yu Tseng, Tainan City (TW)

(21) Appl. No.: 14/789,970

(22) Filed: Jul. 1, 2015

(30) Foreign Application Priority Data
May 12, 2015 (TW) 104114965

(51) Int. Cl. B60Q 1/44; B60Q 1/30; B62D 33/027; B60Q 1/26

(52) U.S. Cl. CPC B60Q 1/44; B60Q 1/2626; B60Q 1/2661; B60Q 1/30; B62D 33/0273

(57) ABSTRACT

A tail lamp assembly is provided to include a tail lamp and a tailgate lamp. The tail lamp assembly replaces the original taillights of a pickup truck with the tail lamp, which is embedded in the side plate of the pickup truck, whereas the tailgate lamp is attached to the tailgate of the pickup truck. The tail lamp is directly controlled by the pickup truck to selectively provide specific warning signals. The tailgate lamp is disposed on a plain surface of the tailgate, extending from the tail lamp at the position within a certain distance from the tail lamp. A light channel or electric channel is selectively established between the tail lamp and the tailgate lamp to link and synchronize the tailgate lamp with the tail lamp, so that the tailgate lamp provides specific warning signals accordingly.

### BACKGROUND OF THE INVENTION

1. Field of the Invention

The invention relates to an accessory for pickup trucks, and more particularly, to an expanded tail lamp assembly for aftermarket of car industry.

2. Description of the Prior Art

Pickup trucks in the market usually refer to light trucks with open carrier that have the features of light weight, capability for loading goods and personnel at the same time, and tougher carrying capacity than ordinary vehicles, and are picked as the mainstream type in car market in some countries. Such type of vehicles are also extensively used in countries with severe environment.

Generally, a pickup truck may be divided into three sections as the engine room, the driver room, and the loading space. The cargo compartment of a pickup truck behind the driver room is provided as an open and uncovered loading space formed and surrounded by two side plates, a tailgate, and a base plate of the pickup truck, where the tailgate is pivoted to the base plate to be rotatable with respect to the base plate to open or close. Loading/unloading of goods can be done when the tailgate is pivoted to open and after that, the tailgate should be rotated to close with respect to the side plates to a closed position and locked to the side plates via bolts or chains so that the goods in the cargo compartment may not fall off during transportation.

On account to the special structure of the pickup trucks, the taillights at the rear end of the vehicles are generally designed to be placed at the end of the side plates of the cargo compartment, leaving the tailgate as simply a structural entity with no power or control wiring. Therefore, the flexibility of designing the taillights and the ability to signaling or warning are limited.

### SUMMARY OF THE INVENTION

It is therefore an objective for the invention to provide a tail lamp assembly configured to be used for a pickup truck to break through the current limitation.

An embodiment of the invention provides a tail lamp assembly for a pickup truck. The pickup truck has an open and uncovered loading space formed and surrounded by two side plates, a tailgate, and a base plate of the pickup truck. The tailgate is pivoted to the base plate and is configurable at an opened position or a closed position with respect to the two side plates. The tail lamp assembly includes a tail lamp and a tailgate lamp. The tail lamp is embedded in one of the side plates and includes a first lamp set and a signal module. The first lamp set is controlled by the pickup truck to selectively provide at least one warning signal. The signal module is controlled by the pickup truck to generate at least one control signal in accordance with the warning signal. The tailgate lamp is attached to the tailgate. The tailgate lamp is adjacent to the tail lamp when the tailgate is configured at the closed position. The tailgate lamp is adapted to receiving the at least one control signal through a signal channel, so as to link and synchronize with the tail lamp and provide at least one warning signal correspondingly.

According to the embodiment of the invention, the tailgate lamp is attached to a plain surface of the tailgate via adhering or bolting.

According to the embodiment of the invention, the tailgate lamp stops receiving the at least one control signal through the signal channel when the tailgate is configured at the opened position.

According to the embodiment of the invention, the signal module is alight provider and the tailgate lamp includes a receiving module being a light receiver, which is adapted to receiving the at least one control signal generated by the specific light provider through the signal channel, so as to provide the at least one warning signal correspondingly.

According to the embodiment of the invention, the tailgate lamp includes a second lamp set. The at least one control signal generated by the light provider has lights at different locations and the second lamp set is adapted to receiving the lights at different locations from the light receiver and reflecting to provide corresponding warning signals at corresponding locations.

According to the embodiment of the invention, the light provider and the light receiver cooperatively form in the shape of a hand grip on the pickup truck.

According to the embodiment of the invention, the tailgate lamp includes a receiving module and a second lamp set. The receiving module is made adjacent to the signal module and the signal channel and/or a power channel is established between the signal module and the receiving module when the tailgate is configured at the closed position.

According to the embodiment of the invention, the receiving module is adapted to receiving the at least one control signal through the signal channel and the second lamp set is adapted to providing the corresponding at least one warning signal.

According to the embodiment of the invention, the tail lamp includes a solenoid valve controlled and activated by the pickup truck to establish the signal channel and/or the power channel between the signal module and the receiving module when the tailgate is configured at the closed position.

According to the embodiment of the invention, the signal channel and/or the power channel is established by the signal module magnetically coupled to the receiving module when the tailgate is configured at the closed position.

According to the embodiment of the invention, the signal module and the receiving module cooperatively form in the shape of a hand grip on the pickup truck.

According to the embodiment of the invention, the tailgate lamp is adjacent to the tail lamp and the tailgate lamp together with the tail lamp form a shape with continuous contour.

According to the embodiment of the invention, the first lamp set includes at least one of an indicator, a warning light, and a stop light, and the tailgate lamp includes at least one of an indicator, a warning light, and a stop light.

The tail lamp assembly provided in the embodiments of the invention is applicable to all types of pickup trucks currently available in the market. It enriches the design of the taillights on any pickup truck, further by extending the taillights to the tailgate. The direct adhesion or bolting of the tailgate lamp to the tailgate saves unnecessary work of manufacturing the tailgate or disposing extra wiring therein, providing a solution of remodeling after the vehicle leaves the factory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a rear part of a pickup truck with the tailgate configured at a closed position.

FIG. 2 is a schematic diagram of the rear part of the pickup truck with the tailgate configured at an opened position.

FIG. 3 is a schematic diagram of how the tail lamp assembly of the invention is assembled to rear end of the pickup truck.

FIG. 4 is a schematic diagram of a functional block view of the tail lamp assembly according to the invention.

FIG. 5 is a schematic diagram of a first embodiment of the signal module and the receiving module according to the invention.

FIG. 6 is a schematic diagram of a second embodiment of the signal module and the receiving module according to the invention.

### DETAILED DESCRIPTION

Certain terms are used throughout the following description and claims to refer to particular system components. As one skilled in the art will appreciate, manufacturers may refer to a component by different names. In the following discussion and in the claims, the terms “include” and “comprise” are used in an open-ended fashion. Also, the term “couple” is intended to mean either an indirect or direct mechanical connection. Thus, if a first device is coupled to a second device, that connection may be through a direct mechanical connection, or through an indirect mechanical connection via other devices and connections.

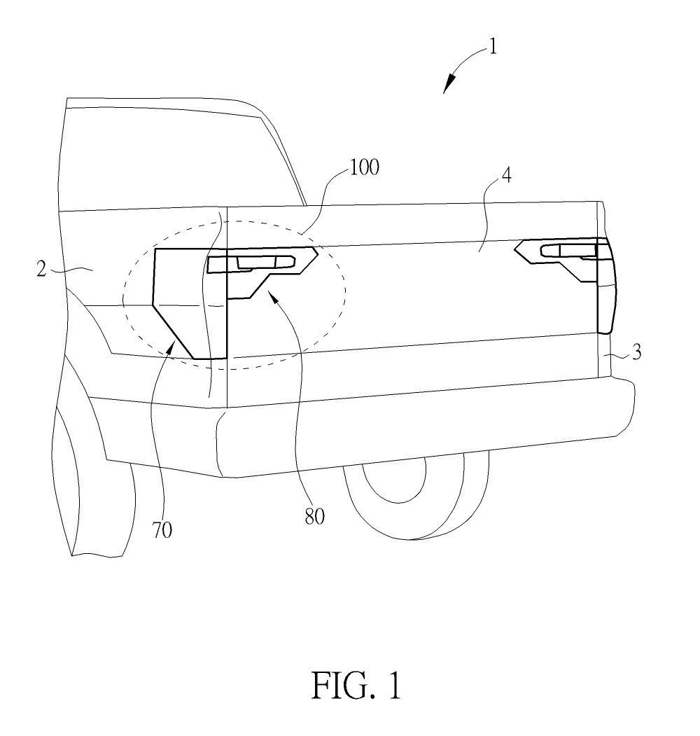

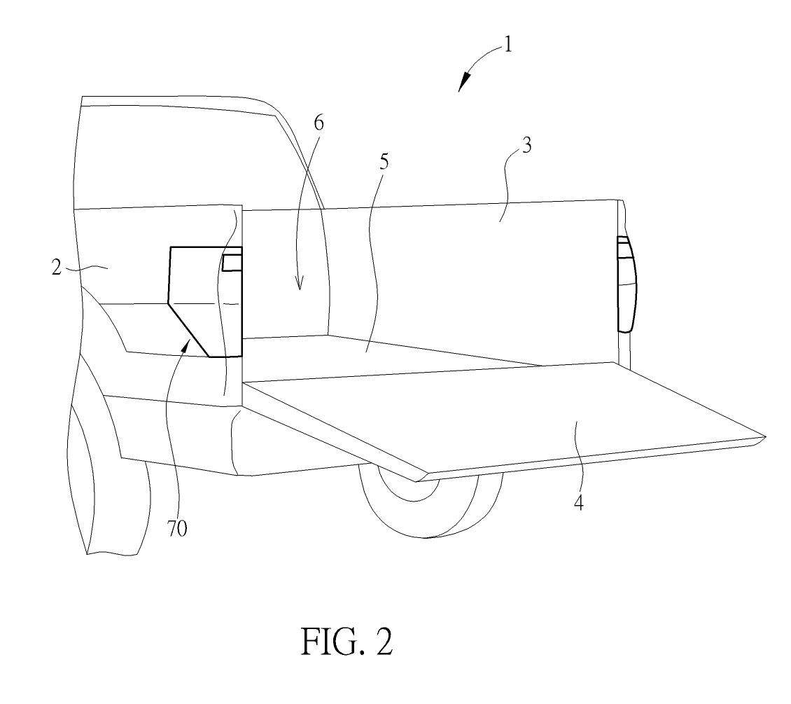

Please refer to FIG. 1 and FIG. 2. FIG. 1 is a schematic diagram of a rear part of a pickup truck with the tailgate configured at a closed position and FIG. 2 is a schematic diagram of the rear part of the pickup truck with the tailgate configured at an opened position. The cargo compartment at the back of a pickup truck 1 is provided as an open and uncovered loading space 6 formed and surrounded by two side plates 2, 3, a tailgate 4 at the rear end, and a base plate 5 at the bottom of the pickup truck 1. The tailgate 4 is pivoted to the base plate 5 and can be rotate with respect to the base plate 5 to open or to close. In FIG. 2, the tailgate 4 is opened to the opened position with respect to the two side plates 2, 3, and when the tailgate 4 is folded upward to close with respect to the side plates 2, 3 to the closed position as shown in FIG. 1, and is further locked to the side plates 2, 3, the goods (not shown) in the cargo compartment may not fall off during transportation.

The tail lamp assembly 100 according to the invention is designed to be disposed at the rear end of the vehicle, more specifically, to replace the original taillights of the pickup truck 1 and have the extensibility to the tailgate 4. The tail lamp assembly 100 includes a tail lamp 70 and a tailgate lamp 80, where in the embodiment as shown in the figures, the pickup truck 1 has two sets of tail lamp assemblies 100, the tail lamps 70 of the tail lamp assemblies 100 embedded in the side plates 2, 3 respectively and the tailgate lamps 80 attached to the tailgate 4.

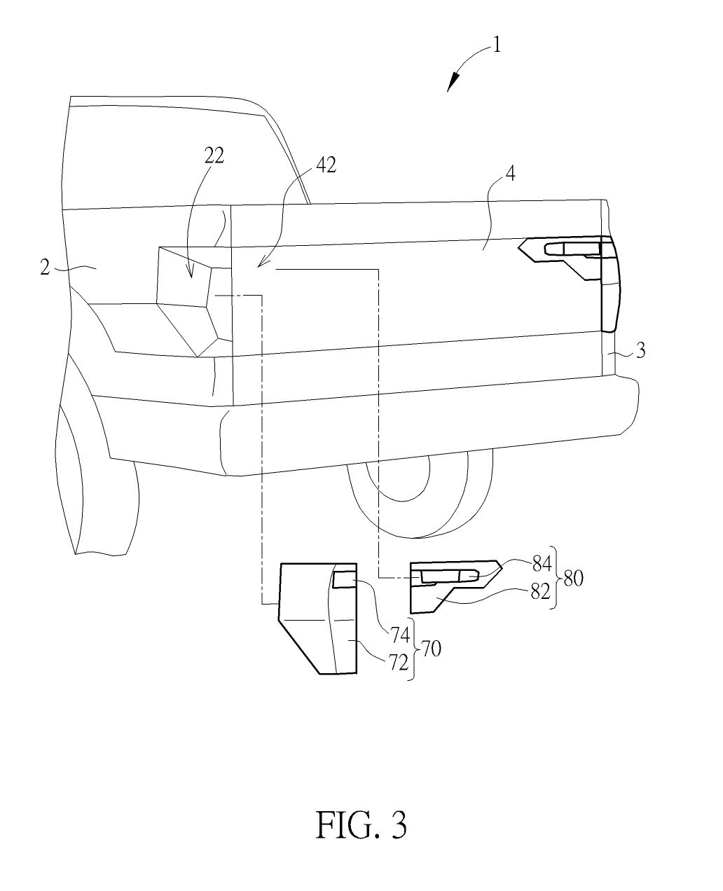

Please refer to FIG. 3, which is a schematic diagram of how the tail lamp assembly 100 of the invention is assembled to rear end of the pickup truck 1. The tail lamp 70 of the tail lamp assembly 100 replaces the original taillights of the pickup truck 1 so as to be embedded in the side plate 2 and share the indentation 22 and wiring originally designed for the original taillights. The tailgate lamp 80 is otherwise attached to a plain surface 42 of the tailgate 4 via adhering or bolting. In other words, for the aftermarket of cars, any pickup truck 1 can be remodeled to extend the use of the tail lamp assembly by replacing the original taillights with the tail lamp 70 of the invention and further attaching the tailgate lamp 80 to the tailgate 4.

Please keep referring to FIG. 3. The tail lamp 70 includes a first lamp set 72 and a signal module 74. The first lamp set 72 is assembled to the car body through the indentation 22 and wiring therein and can be controlled by the pickup truck 1 to selectively provide at least one warning signal. For example, the first lamp set 72 may include at least one of an indicator, a warning light, a stop light, and lights with other possible use, whereas the pickup truck 1 may control the first lamp set 72 to selectively turn on any one of the above lights and provide corresponding warning signal. The tailgate lamp 80 includes a second lamp set 82 and a receiving module 84 and when the tailgate 4 is configured at the closed position as shown in FIG. 1, the tailgate lamp 80 is adjacent to the tail lamp 70 and the tailgate lamp 80 together with the tail lamp 70 form a shape with continuous contour. More specifically, since the tailgate lamp 80 of the invention is attached to the plain surface 42 of the tailgate 4, the tailgate lamp 80 will protrude on the tailgate 4 in more extent than the original taillights that is embedded in the side plate 2 and after the tail lamp 70 of the invention replaces the original taillights and is assembled in the indentation 22 of the side plate 2, the tail lamp 70 of the invention protrudes from the side plate 2 in substantially equal extent as the tailgate lamp 80, so that both the tail lamp 70 and the tailgate lamp 80 may be cooperatively continuous in shape. Additionally, the signal module 74 of the tail lamp 70 and the receiving module 84 of the tailgate lamp 80 preferably form in the shape of a hand grip on the pickup truck 1 cooperatively. The second lamp set 82 of the tailgate lamp 80 may also include at least one of an indicator, a warning light, a stop light, and lights with other possible use that corresponds to the first lamp set 72, and in such way, the warning signals of the tail lamp assembly 100 may be extended from the side plate 2 and/or side plate 3 to the tailgate 4. In other embodiment of the invention, the indicator, the warning light, and the stop light may also be separately configured to be disposed at the first lamp set 72 and the second lamp set 82 without the need to have any one light at both lamp sets. For example, the first lamp set 72 may include the indicator and the warning light while the second lamp set 82 may include the stop light and the extending warning light corresponding to the first lamp set 72. However, the invention is not limited to what is described in the embodiment.

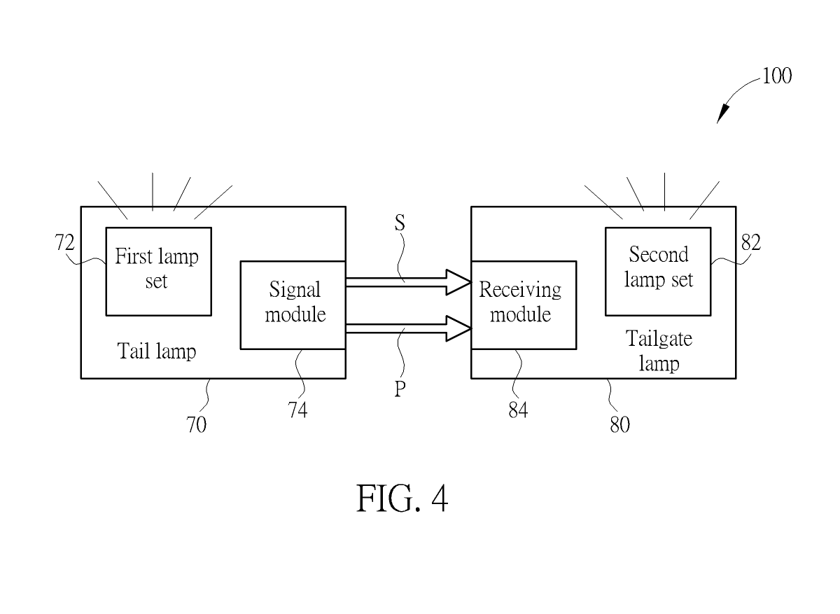

Please refer to FIG. 4. FIG. 4 is a schematic diagram of a functional block view of the tail lamp assembly according to the invention. As described, when the tailgate 4 is configured at the closed position as shown in FIG. 1, the tailgate lamp 80 is adjacent to the tail lamp 70 and the signal module 74 of the tail lamp 70, according to the control from the pickup truck 1, thus generates control signals in accordance with the warning signals, the indicator, the warning light, and the stop light, of the first lamp set 72, for example, the control signal of the indicator, the control signal of the warning light, and/or the control signal of the stop light. The at least one or more control signals are then transmitted to the adjacent receiving module 84 through a signal channel S and on receiving the control signals, the tailgate lamp 80 links and synchronizes with the tail lamp 70 and provides at least one warning signal, the indicator, the warning light, and/or the stop light, correspondingly. The tailgate lamp 80 will stop receiving the at least one control signal through the signal channel S when the tailgate 4 is opened from the closed position with respect to the side plates 2, 3 to the opened position as shown in FIG. 4, i.e., the tailgate lamp 80 is controlled directly by the tail lamp 70 and can be activated and controlled by the tail lamp 70 when the tailgate 4 is at the closed position.

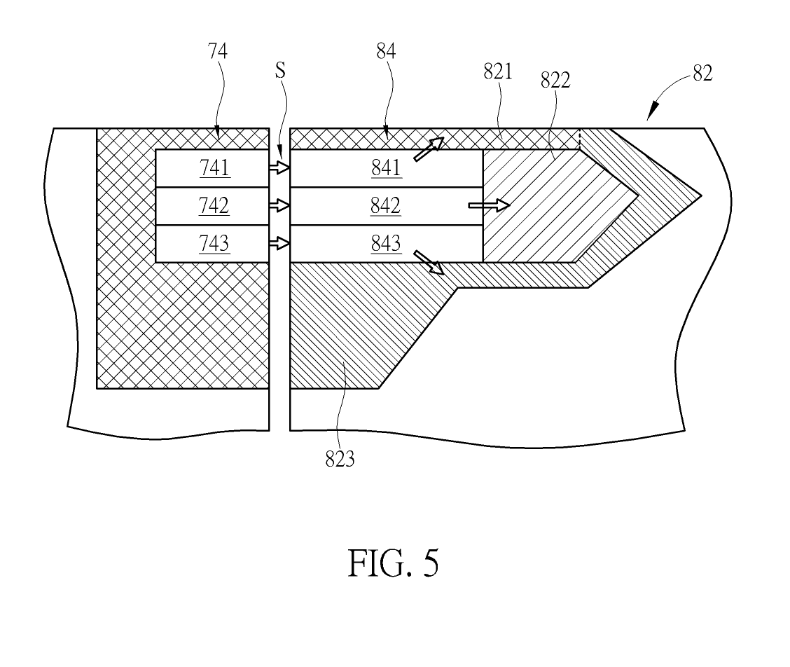

Several embodiments are provided here to demonstrate how the tail lamp assembly 100 of the invention can be implemented on a pickup truck to show the control of the tailgate lamp 80 providing corresponding warning signals given the structure described above. In one embodiment for example, the signal module of the tail lamp 70 can be a light provider and the receiving module 84 of the tailgate lamp 80 can be a light receiver. As described earlier, the light provider and the light receiver cooperatively form in the shape of a hand grip on the pickup truck 1. Please refer to FIG. 5, which is a schematic diagram of a first embodiment of the signal module and the receiving module according to the invention. The signal module 74 generates the at least one control signal in the form of directly providing lights and projecting the lights toward the receiving module 84. In other words, the receiving module 84 (or the tailgate lamp 80) receives the lights from a specific light source, the tail lamp 70, and the receiving module 84 provides the at least one warning signal correspondingly, in which the signal channel S aforementioned is the path the lights are conveyed. To be more specifically, the signal module 74, the light provider, of the embodiment in FIG. 5 includes a first light source 741, a second light source 742, and a third light source 743, which emit lights from different locations. The receiving module 84, the light receiver, includes a first receiver 841, a second receiver 842, and a third receiver 843, which correspond to the locations of the first light source 741, the second light source 742, and the third light source 743 respectively. The first receiver 841 guides the lights to a first warning lamp 821 of the second lamp set 82, the second receiver 842 guides the lights to a second warning lamp 822 of the second lamp set 82, and the third receiver 843 guides the lights to a third warning lamp 823 of the second lamp set 82. The first warning lamp 821, the second warning lamp 822, and the third warning lamp 823 each have its own color and shape cooperative with the first lamp set, which is not shown in FIG. 5, and present warning signals functioning in different purposes. When the tail lamp 70 is controlled by the pickup truck 1 and a warning signal such as an indicator is provided, the signal module 74 also generates a control signal in accordance with the warning signal according to the control of the pickup truck 1. For example, the control signal is the lights generated by the first light source 741, which is then received by the first receiver 841 and reflected out by the first warning lamp 821 to be recognized as the corresponding warning signal on the second lamp set 82, which in this case is also an indicator. The second and the third warning signals from the tail lamp 70 and the way how the tailgate lamp 80 is activated to provide corresponding warning signals are similar as the case of the first warning signal and the description is herein omitted for brevity.

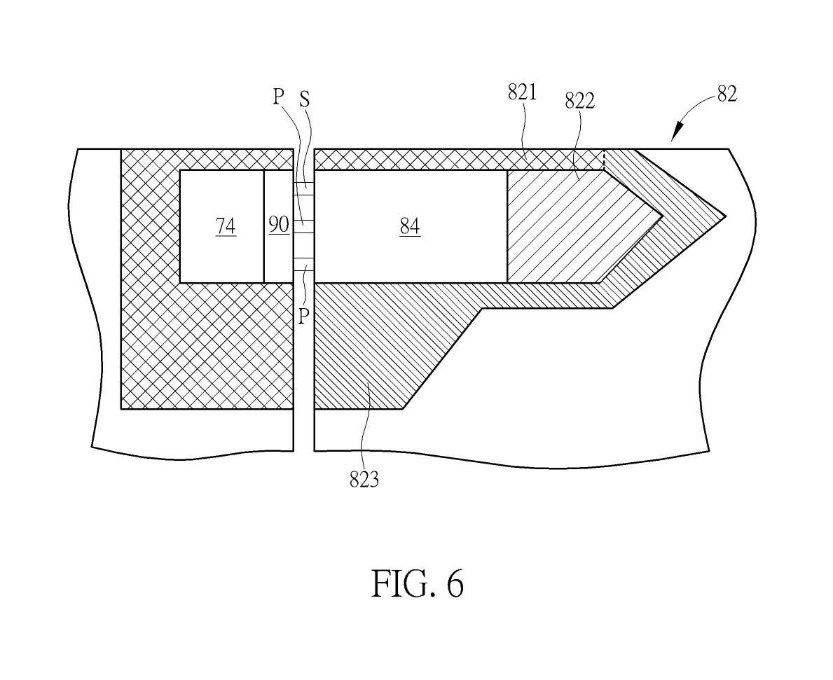

Please refer to FIG. 6, which is a schematic diagram of a second embodiment of the signal module and the receiving module according to the invention. Besides the direct light transmission way as described above, the invention also provides another embodiment that establishes a signal and/or a power channel between the signal module 74 and the receiving module 84 and the second lamp set 82 is controlled by the receiving module 84 to illuminate actively. As shown in FIG. 6, the tail lamp 70 further include a solenoid valve 90 disposed at a location in the signal module 74 and adjacent to the receiving module 84. When the tailgate 4 is configured at the closed position as shown in FIG. 1, the pickup truck 1 is able to activate the solenoid valve 90 to connect directly between the signal module 74 and the receiving module 84 and utilizes its three connection pins between the signal module 74 and the receiving module 84 to establish the signal channel S and/or the power channel P. The receiving module 84 can be powered through the power channel P, receive the control signals through the signal channel S, and control the second lamp set 82, such as the first warning 821, the second warning lamp 822, or the third warning lamp 823, to provide the corresponding warning signals.

Besides the embodiment in FIG. 6 that uses the solenoid valve as the establishment of connection between the modules, by extending electrodes to connect to the hand-grip like receiving module 84, in a third embodiment of the signal module 74 and the receiving module 84, magnetic elements are disposed between the signal module 74 and the receiving module 84 and the signal channel S and/or the power channel P is established by the signal module 74 magnetically coupled to the receiving module 84. The receiving module 84, as the second embodiment above, can be powered through the power channel P, receive the control signals through the signal channel S, and control the second lamp set 82, such as the first warning 821, the second warning lamp 822, or the third warning lamp 823, to provide the corresponding warning signals.

The tail lamp assembly provided in the invention includes the tail lamp and the tailgate lamp. The tail lamp assembly replaces the original taillights of the pickup truck with the tail lamp, which is embedded in the side plate of the pickup truck, whereas the tailgate lamp is attached to the tailgate of the pickup truck. The tail lamp is directly controlled by the pickup truck to selectively provide specific warning signals. The tailgate lamp is disposed on the plain surface of the tailgate, extending from the tail lamp at the position within a certain distance from the tail lamp. A light channel or electric channel is selectively established between the tail lamp and the tailgate lamp, with lights, solenoid valve, or magnetic attraction, to link and synchronize the tailgate lamp with the tail lamp, so that the tailgate lamp provides specific warning signals accordingly. No further work of manufacturing the tailgate or disposing extra wiring therein is needed and the vehicles can be remodeled with a variety of options of tail lamp designs, including extending the taillights to the tailgate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A tail lamp assembly for a pickup truck, wherein the pickup truck has an open and uncovered loading space formed and surrounded by two side plates, a tailgate, and a base plate of the pickup truck, the tailgate pivoted to the base plate and configurable at an opened position or a closed position with respect to the two side plates, the tail lamp assembly comprising:
a tail lamp, embedded in one of the side plates and comprising a first lamp set and a signal module, the first lamp set controlled by the pickup truck to selectively provide at least one warning signal, the signal module controlled by the pickup truck to generate at least one control signal in accordance with the warning signal; and
a tailgate lamp, attached to the tailgate, the tailgate lamp adjacent to the tail lamp when the tailgate is configured at the closed position, the tailgate lamp adapted to receiving the at least one control signal through a signal channel, so as to link and synchronize with the tail lamp and provide at least one warning signal correspondingly.

2. The tail lamp assembly of claim 1, wherein the tailgate lamp is attached to a plain surface of the tailgate via adhering or bolting.

3. The tail lamp assembly of claim 1, wherein the tailgate lamp stops receiving the at least one control signal through the signal channel when the tailgate is configured at the opened position.

4. The tail lamp assembly of claim 1, wherein the signal module is a light provider, the tailgate lamp comprising a receiving module being a light receiver, the light receiver adapted to receiving the at least one control signal generated by the specific light provider through the signal channel, so as to provide the at least one warning signal correspondingly.

5. The tail lamp assembly of claim 4, wherein the tailgate lamp comprises a second lamp set, the at least one control signal generated by the light provider comprising lights at different locations, the second lamp set adapted to receiving the lights at different locations from the light receiver and reflecting to provide corresponding warning signals at corresponding locations.

6. The tail lamp assembly of claim 4, wherein the light provider and the light receiver cooperatively form in the shape of a hand grip on the pickup truck.

7. The tail lamp assembly of claim 1, wherein the tailgate lamp comprises a receiving module and a second lamp set, the receiving module made adjacent to the signal module and the signal channel and/or a power channel being established between the signal module and the receiving module when the tailgate is configured at the closed position.

8. The tail lamp assembly of claim 7, wherein the receiving module is adapted to receiving the at least one control signal through the signal channel and the second lamp set is adapted to providing the corresponding at least one warning signal.

9. The tail lamp assembly of claim 7, wherein the tail lamp comprises a solenoid valve controlled and activated by the pickup truck to establish the signal channel and/or the power channel between the signal module and the receiving module when the tailgate is configured at the closed position.

10. The tail lamp assembly of claim 7, wherein the signal channel and/or the power channel is established by the signal module magnetically coupled to the receiving module when the tailgate is configured at the closed position.

11. The tail lamp assembly of claim 7, wherein the signal module and the receiving module cooperatively form in the shape of a hand grip on the pickup truck.

12. The tail lamp assembly of claim 1, wherein the tailgate lamp is adjacent to the tail lamp and the tailgate lamp together with the tail lamp form a shape with continuous contour.

13. The tail lamp assembly of claim 1, wherein the first lamp set comprises at least one of an indicator, a warning light, and a stop light, and the tailgate lamp comprises at least one of an indicator, a warning light, and a stop light.
